(19) United States
(12) Patent Application Publication
(10) Pub. No.: US 2022/0398529 A1
(43) Pub. Date: Dec. 15, 2022

(54) BAR TYPE ELECTRONIC SHELF LABEL CAPABLE OF TOUCH INPUT

(71) Applicant: RAINUS CO., LTD., Seongnam-si, Gyeonggi-do (KR)

(72) Inventors: Jong Woo SUNG, Seongnam-si, Gyeonggi-do (KR); Hyun-Hak KIM, Seongnam-si, Gyeonggi-do (KR)

(21) Appl. No.: 17/771,413

(22) PCT Filed: Sep. 25, 2020
(86) PCT No.: PCT/KR2020/013045

§ 371 Date: Apr. 22, 2022

(30) Foreign Application Priority Data
May 21, 2020 (KR) 10-2020-0061082

(51) Int. Cl. G06Q 10/08; G06F 3/14; G06F 3/04886; G06F 3/04845; G06Q 30/06

(52) U.S. Cl. CPC G06Q 10/087; G06F 3/14; G06F 3/04886; G06F 3/04845; G06Q 30/0623; G06F 3/0482

(57) ABSTRACT

According to an embodiment of the present disclosure, an electronic shelf label capable of touch input includes a display configured to receive touch input from a user and display information to a user on a screen; and a controller configured to control the screen displayed by the display based on the input received through the display, the controller is configured to: control the display to be operated in a consumer mode in which product information is displayed to the user or a manager mode in which a screen displayed in the consumer mode is set.

### TECHNICAL FIELD

The present disclosure relates to an electronic shelf label, and more particularly, to a bar type electronic shelf label capable of touch input that may provide various functions to a user according to an input received through a display capable of touch input.

### BACKGROUND ART

A large number of products on sale are displayed on a display stand in stores such as large marts. A label of recording product information such as product name, product price, and product shelf-life is attached to the display stand, and customers may identify the product information by checking the label.

The displayed products are sold within a short time period in stores where products are quickly distributed, so the product information displayed on the label may be frequently changed. Therefore, an electronic shelf label (ESL) is widely used in stores to easily change the product information displayed on the label and to repeatedly use.

The ESL receives and displays various pieces of product information including price information. The ESL is a substitute for other paper labels and may display product information.

FIG. 1 shows a conventional ESL used to display product information on product displayed on a display stand of a store.

Referring to FIG. 1, it may be seen that a plurality of ESLs 10 are used to display product information on a plurality of products displayed on the display stand. In order to display the product information on the ESL 10 as described above, a store manager may place the ESL 10 according to the position of the product displayed on the display stand and map the individual ESL 10 to the displayed product using a terminal device 20 such as a PDA. Specifically, a process of storing mapping information in a management server 30 by reading the unique number of the ESL 10 and an identification code of the product to be mapped by the terminal device 20 using means such as a barcode or NFC is performed. Subsequently, the ESL 10 receives the information on the mapped product from the management server 30 and displays the product information.

The manager has to map the individual ESL 10 to the product while carrying the terminal device 20 to use the ESL 10 as described above. There is a problem in that the ESL 10 may not be controlled if an abnormality occurs in the terminal device 20.

In addition, the manager has to arrange a different number of ESLs 10 according to the number of types of products displayed on a display stand. That is, as the number of types of products displayed on the display stand is changed, the manager experiences inconvenience of having to change the number of ESLs 10 arranged on the display stand.

In addition, there is a problem in that the ESL 10 according to the related art may not perform functions other than the function for displaying the information to the consumer.

### DISCLOSURE

### Technical Problem

The present disclosure provides a bar type electronic shelf label capable of touch input that may change displayed product information by a manager without an additional terminal device.

The present disclosure also provides a bar type electronic shelf label capable of touch input that may display various pieces of information according to selection of a customer.

The present disclosure further provides a bar type electronic shelf label capable of touch input that enables a manager to easily manage the inventory of displayed products.

The objects of the present disclosure are not limited to the above-mentioned objects, and other objects and advantages of the present disclosure that are not mentioned may be understood by the following description, and will be more clearly understood by embodiments of the present disclosure. In addition, it will be easily understood that the objects and advantages of the present disclosure may be realized by features described in claims and a combination thereof.

### Technical Solution

According to an embodiment of the present disclosure, a bar type electronic shelf label capable of touch input includes a display configured to receive touch input from a user and display information to a user on a screen; and a controller configured to control the screen displayed by the display based on the input received through the display, the controller is configured to: control the display to be operated in a consumer mode in which product information is displayed to the user or a manager mode in which a screen displayed in the consumer mode is set, when the controller controls the display to be operated in the manager mode, generate a virtual cell by dividing the screen based on a division input received from the user and match a product identification code to each virtual cell based on a virtual cell selection input and a product identification input received from the user, and when the controller controls the display to be operated in the consumer mode, control the display to display product information corresponding to the product identification code on the each virtual cell.

In addition, according to an embodiment of the present disclosure, for the bar type electronic shelf label capable of touch input, the division input includes at least one of an input having a number of virtual cells desired to be generated, a touch input having the number corresponding to the number of virtual cells desired to be generated, a touch input to a desired location to be divided, or an input to receive a preset template from a management server.

In addition, according to an embodiment of the present disclosure, the controller of the bar type electronic shelf label capable of touch input is configured to: when the controller controls the display to be operated in the manager mode, adjust a size and the number of virtual cells based on a virtual cell adjustment input from the user after receiving the division input.

In addition, according to an embodiment of the present disclosure, the controller of the bar type electronic shelf label capable of touch input is configured to: when the controller controls the display to be operated in the consumer mode, based on an additional information display input being received from the user, control additional information to be displayed on the virtual cell that has received the additional information display input for a preset display time period.

In addition, according to an embodiment of the present disclosure, the controller of the bar type electronic shelf label capable of touch input is configured to: when the controller controls the display to be operated in the consumer mode, based on a related product display input being received from the user, control related product information to be displayed on a virtual cell that has received the related product display input for a preset display time period.

In addition, according to an embodiment of the present disclosure, the controller of the bar type electronic shelf label capable of touch input is configured to: when the controller controls the display to be operated in the consumer mode, based on a purchase wish input being received from a user, control a purchase information set window to be displayed on a virtual cell that has received the purchase wish input.

In addition, according to an embodiment of the present disclosure, the controller of the bar type electronic shelf label capable of touch input is configured to: based on user information input being received in a state in which the purchase information set window is displayed, transmit the user information input and the product identification code corresponding to the virtual cell displaying the purchase information set window to a management server.

In addition, according to an embodiment of the present disclosure, the controller of the bar type electronic shelf label capable of touch input is configured to: when the controller controls the display to be operated in the consumer mode, based on a prize lottery input being received from the user, control a winning phase or a losing phase to be displayed on a virtual cell that has received the prize lottery input based on a preset winning probability.

In addition, according to an embodiment of the present disclosure, the controller of the bar type electronic shelf label capable of touch input is configured to: based on an inventory management input being received from the user, control the display to display an inventory set window.

In addition, according to an embodiment of the present disclosure, the controller of the bar type electronic shelf label capable of touch input is configured to: based on an inventory quantity input received in a state in which the inventory set window is displayed, transmit, to the management server, the inventory quantity input and a product identification code corresponding to the virtual cell that has received the inventory quantity input.

In addition, according to an embodiment of the present disclosure, the controller of the bar type electronic shelf label capable of touch input is configured to: when the controller controls the display to be operated in the consumer mode, based on a manager mode operation input received from the user, control the display to be operated in the manager mode.

In addition, according to an embodiment of the present disclosure, for the electronic shelf label capable of touch input, the manager mode operation input includes at least one of an input of touching the display in accordance with a preset rhythm, an input of pressing adjustment switching button of the electronic shelf label, or a preset password input.

In addition, according to an embodiment of the present disclosure, the controller of the bar type electronic shelf label capable of touch input is configured to: based on the manager mode operation input received and the display being operated in the manager mode, control the display to display a barcode corresponding to the product identification code matching to the each virtual cell.

In addition, according to an embodiment of the present disclosure, the controller of the bar type electronic shelf label capable of touch input is configured to: when the controller controls the display to be operated in the manager mode, based on no input received from the user for a preset waiting time period or a set completion input received from the user, control the display to be operated in the consumer mode.

### Advantageous Effects

According to the present disclosure, a bar type electronic shelf label capable of touch input is used to change displayed product information by a manager without an additional terminal device.

In addition, according to the present disclosure, the bar type electronic shelf label capable of touch input is used to provide varies pieces of information to consumers by displaying various pieces of information on a display according to selection of consumers under the control of a controller.

In addition, the manager may easily manage the inventory of displayed products using the bar type electronic shelf label capable of touch input according to the present disclosure.

In addition to the above-described effects, further effects of the present disclosure are described together with explanations of specific matters to implement the present disclosure.

### DESCRIPTION OF DRAWINGS

FIG. 1 shows a conventional electronic shelf label used to display product information of products displayed on a display stand of a store.

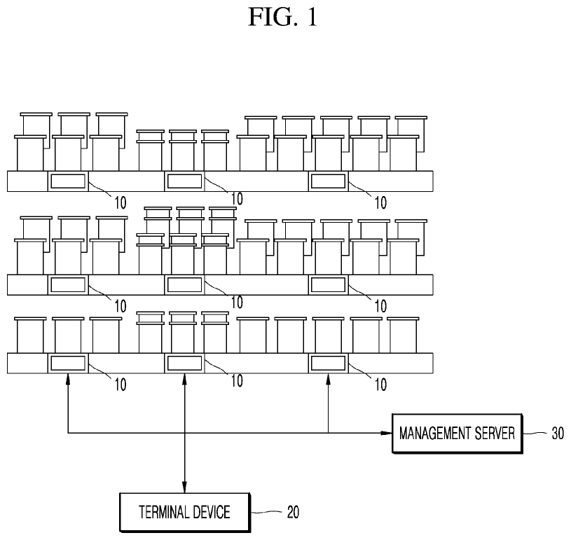

FIG. 2 shows a bar type electronic shelf label capable of touch input according to an embodiment of the present disclosure.

FIG. 3 is a flowchart of a method for operating a bar type electronic shelf label capable of touch input according to an embodiment of the present disclosure in a manager mode.

FIG. 4 shows a screen displayed when a display of a bar type electronic shelf label capable of touch input according to an embodiment of the present disclosure receives a division input.

FIG. 5 shows a screen on which a virtual cell generated on a display of a bar type electronic shelf label capable of touch input according to an embodiment of the present disclosure is adjusted.

FIG. 6 shows a method for matching a product identification code to each virtual cell generated on a display of a bar type electronic shelf label capable of touch input according to an embodiment of the present disclosure.

FIG. 7 shows a screen change occurring according to a user input when a bar type electronic shelf label capable of touch input according to an embodiment of the present disclosure is operated in a consumer mode.

FIG. 8 shows a screen displayed on a display when a bar type electronic shelf label capable of touch input according to an embodiment of the present disclosure receives an inventory management input.

FIG. 9 is a flowchart of a method for switching between a consumer mode and a manager mode of a bar type electronic shelf label capable of touch input according to an embodiment of the present disclosure.

FIG. 10 shows a screen change occurring when a mode of a bar type electronic shelf label capable of touch input according to an embodiment of the present disclosure is switched from a consumer mode to a manager mode.

### BEST MODE

The above-mentioned objects, features, and advantages of the present disclosure are described in detail with reference to accompanying drawings. Therefore, the skilled person in the art to which the present disclosure pertains may easily embody the technical idea of the present disclosure. In the description of the present disclosure, a detailed description of a well-known technology relating to the present disclosure may be omitted if it unnecessarily obscures the gist of the present disclosure. Hereinafter, preferred embodiments of the present disclosure are described in detail with reference to the accompanying drawings. In the drawings, same reference numerals are used to refer to same or similar components.

Terms such as first, second, and the like may be used herein to describe various elements of the present disclosure. These elements are not limited by these terms. These terms are intended to distinguish one element from another element. A first element may be a second element unless otherwise stated.

Further, the terms “connected,” “coupled,” or the like are used such that, where a first component is connected or coupled to a second component, the first component may be directly connected or able to be connected to the second component, or one or more additional components may be disposed between the first and second components, or the first and second components may be connected or coupled through one or more additional components.

Singular expressions used in the present disclosure include plural expressions unless the context clearly displays otherwise. In the present disclosure, terms such as “including” or “comprising” should not be construed as necessarily including all of the various components, or various steps described in the present disclosure, and terms such as “including” or “comprising” should be construed as not including some elements or some steps or further including additional elements or steps.

Unless otherwise stated, each component may be singular or plural throughout the disclosure.

Hereinafter, a bar type electronic shelf label capable of touch input according to some embodiments of the present disclosure is described.

Hereinafter, a user refers to any person using the bar type electronic shelf label. In addition, a manager refers to a person using the bar type electronic shelf label to manage products sold in the store among users and a consumer refers to a person using the bar type electronic shelf label to obtain product information or purchase products in a store among users.

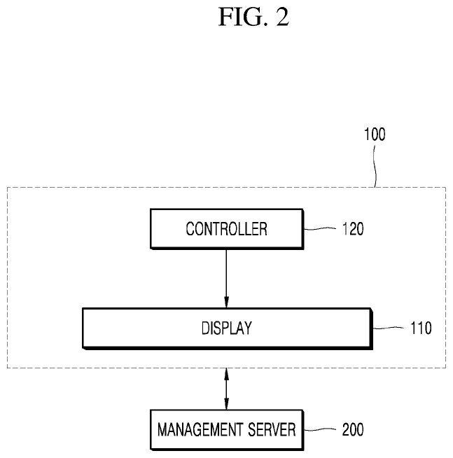

FIG. 2 shows a bar type electronic shelf label capable of touch input according to an embodiment of the present disclosure.

Referring to FIG. 2, a bar type electronic shelf label 100 capable of touch input according to an embodiment of the present disclosure includes a display 110 and a controller 120.

According to an embodiment of the present disclosure, the electronic shelf label 100 capable of touch input may have a bar shape and a horizontal length thereof is longer than a vertical length thereof when the electronic shelf label 100 is coupled to a display stand. With this structure of the electronic shelf label 100 capable of touch input, an electronic shelf label 100 may display product information on a plurality of products.

The display 110 receives touch input from a user and displays information to the user on a screen. That is, the display 110 receives the touch input from the user, transmits the touch input to the controller 120, and displays the information to the user according to a command received from the controller 120.

In an embodiment of the present disclosure, the display 110 may be a touch screen capable of displaying information to the user on the screen while receiving the touch input from the user.

The controller 120 controls the screen displayed by the display 110 based on the input received through the display 110. The controller 120 may include a memory to store instructions for controlling the screen displayed by the display 110 based on the input received through the display 110, a processor to process the instructions stored in the memory, and a communication module to communicate with a management server 200 described below.

The controller 120 may control the display 110 to be operated in a consumer mode or a manager mode.

The consumer mode is a mode in which product information is displayed to the consumer. When the electronic shelf label 100 is operated in the consumer mode, the controller 120 may control the display 110 to display a different screen according to the input received through the display 110. In addition, when the electronic shelf label 100 is operated in the consumer mode, the controller 120 may transmit data to the management server 200 described below based on the input received through the display 110.

The manager mode is a mode in which the user may set the screen displayed in the consumer mode. When the electronic shelf label is operated in the manager mode, the user applies the input to the display 110 to divide the screen displayed on the display 110 into virtual cells and match the divided virtual cell to the product.

The manager mode includes an inventory management mode in which inventory management may be performed using the electronic shelf label 100. When the electronic shelf label 100 is operated in the consumer mode or the manager mode, the user may operate the electronic shelf label 100 in the inventory management mode by applying an inventory management input to the display 110.

The management server 200 stores product information on products displayed on a display stand of a store. That is, the management server 200 stores a product identification code of each of all products displayed in the store and product information corresponding thereto. In addition, the management server 200 may store various pieces of information necessary for the operation of the electronic shelf label 100.

The management server 200 communicates with the controller 120 of the electronic shelf label 100. The management server 200 may transmit product information to be displayed on the screen of the display 110 of the electronic shelf label 100 and receive product information currently displayed on the electronic shelf label 100.

In addition, the management server 200 may process various calculations based on the data received from the electronic shelf label 100.

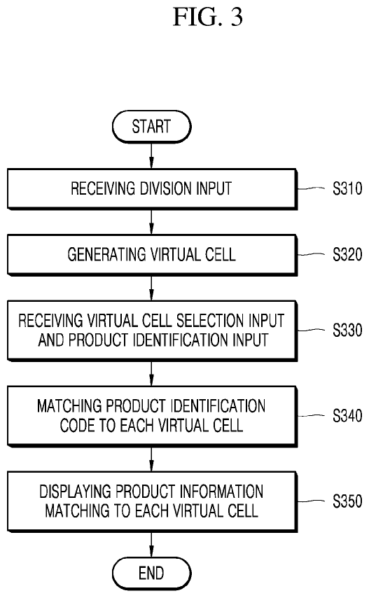

A more detailed operation of the electronic shelf label 100 including the display 110 and the controller 120 as described above may be described with reference to FIGS. 3 to 8.

FIG. 3 is a flowchart of a method for operating a bar type electronic shelf label capable of touch input according to an embodiment of the present disclosure in a manager mode.

Referring to FIG. 3, when a controller 120 controls a display 110 to be operated in the manager mode, an electronic shelf label 100 receives a division input from the user through a display 110 (S310). After receiving the division input, the controller 120 divides a screen of the display 110 based on the division input received from the user and generates a virtual cell (S320).

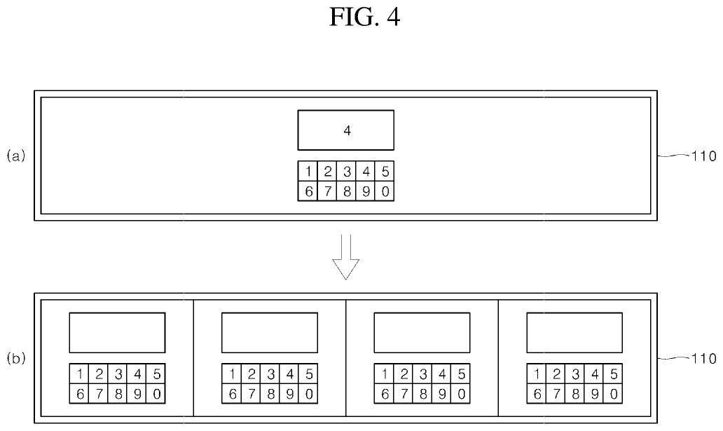

In an embodiment of the present disclosure, the division input may include a number of virtual cells desired to be generated. In order to receive such a division input, the controller 120 may control the display 110 to display a virtual keypad and an input result window. This configuration may be described in more detail with reference to FIG. 4.

FIG. 4 shows a screen displayed when a display of a bar type electronic shelf label capable of touch input according to an embodiment of the present disclosure receives a division input.

Referring to FIG. 4, as shown in (a) of FIG. 4, in an embodiment of the present disclosure, a display 110 may display an input result window and a virtual keypad on a screen. The virtual keypad is a tool that helps the user to input letters, numbers, and the like, and the user may input the letters by touching a specific area of the virtual keypad displayed on the display 110. The input result window displays the input applied to the virtual keypad, and the user may determine whether the input is correctly applied by checking the input result window. In this case, the input result window may be displayed at an upper portion of the screen and the virtual keypad may be displayed at a lower portion of the screen.

In the displayed state, the user may apply an input of the number of virtual cells desired to be generated with a division input using the virtual keypad. That is, the electronic shelf label 100 receives, through the display 110, the input of the number of virtual cells desired to be generated with the division input (S310). In this case, the division input received from the user may be displayed on the input result window of the display. For example, the user may input 4 using the virtual keypad with the division input, and the 4, which is input by the division input, may be displayed on the input result window.

After receiving the division input, the controller 120 generates a virtual cell by dividing the screen of the display 110 based on the division input received from the user (S320). In the embodiment shown in FIG. 4, as the received division input is 4, the controller 120 may divide the screen into four virtual cells as shown in (b) of FIG. 4. In this case, the controller 120 may divide the screen into the four virtual cells having the same size. In addition, the generated four virtual cells may each display an input result window and a virtual keypad to select a product identification input described below.

As described above, in an embodiment of the present disclosure, the controller 120 controls the display 110 to display the virtual keypad and the input result window to receive the division input and generate the virtual cell.

Referring back to FIG. 3, in another embodiment of the present disclosure, the division input may be a touch input having the number corresponding to the number of virtual cells desired to be generated. For example, if the user desires the screen to be divided into four virtual cells, the user may apply a four-touch input to the screen with a division input.

In yet another embodiment of the present disclosure, the division input may be touch input to a position where the screen is desired to be divided. For example, if the user desires to divide the screen into two virtual cells, the user may apply a division input by touching a position where a boundary line between the two virtual cells is desired to be located.

In addition, in yet another embodiment of the present disclosure, the division input may be an input to receive a preset template from the management server 200. The template has a form in which a manager divides into virtual cells and may include virtual cell information such as number information and size information of the virtual cell generated by dividing the screen.

For example, when the user applies an input to receive the preset template with division input, the controller 120 may request the management server 200 for the template, receive the template from the management server 200, and generate a virtual cell based on the virtual cell information of the template.

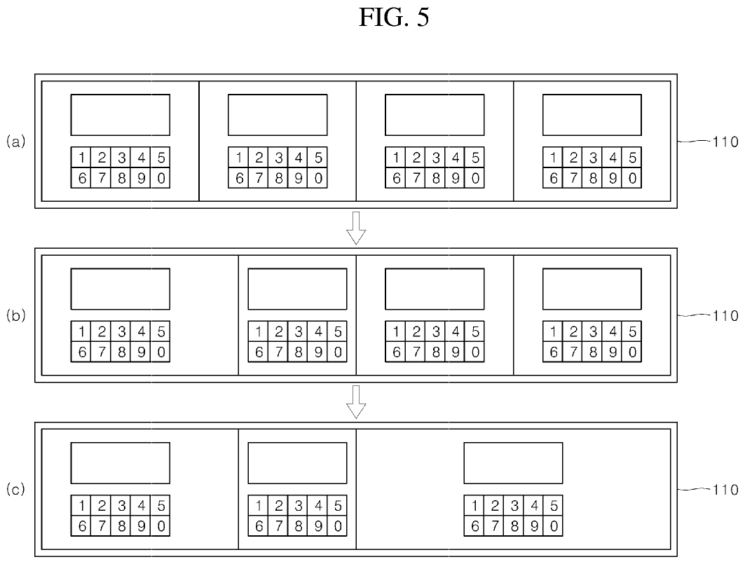

After the controller 120 generates the virtual cell based on the division input, when the controller 120 controls the display 110 to be operated in the manager mode, the size and the number of the virtual cell may be adjusted based on a virtual cell adjustment input received from the user. According to an embodiment of the present disclosure, the virtual cell adjustment input may include an input to adjust the size of a virtual cell, an input to merge a plurality of virtual cells into a virtual cell, and the like. This configuration may be described in more detail with reference to FIG. 5. FIG. 5 shows a screen on which a virtual cell generated on a display of a bar type electronic shelf label capable of touch input according to an embodiment of the present disclosure is adjusted.

Referring to FIG. 5, a virtual cell adjustment input may be received in a state in which a total of four virtual cells are generated as shown in (a) of FIG. 5. According to an embodiment of the present disclosure, an input to increase a size of a first virtual cell and reducing a size of a second virtual cell may be received as a virtual cell adjustment input. Based on the input, the controller 120 may control the sizes of the virtual cells to be adjusted as shown in (b) of FIG. 5. In addition, in a state in which the sizes of the virtual cells are adjusted as shown in (b) of FIG. 5, an input to merge a third virtual cell and a fourth virtual cell into a virtual cell may be received. Based on the input, the controller 120 may adjust the virtual cells to be merged as shown in (c) of FIG. 5.

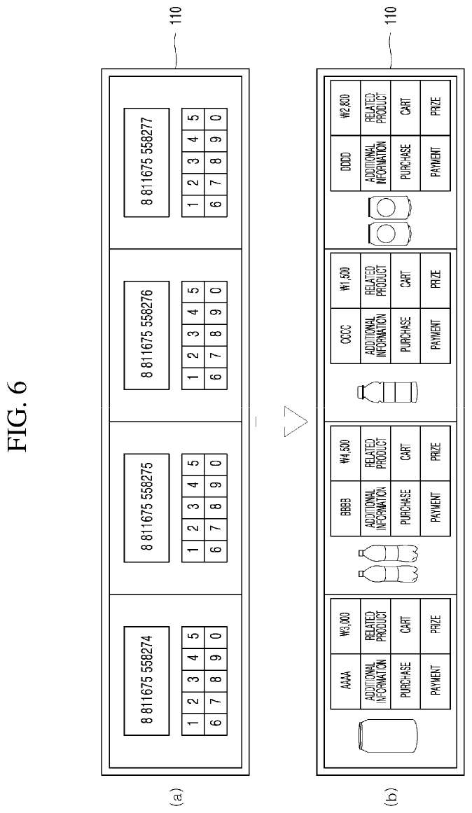

Referring back to FIG. 3, after the controller 120 generates the virtual cell, the electronic shelf label 100 receives a virtual cell selection input and a product identification input through the display 110 (S330). After receiving the virtual cell selection input and the product identification input, the controller 120 matches the product identification code to each virtual cell based on the virtual cell selection input and the product identification input received from the user (S340). After matching the product identification code to each virtual cell, the controller 120 controls the display 110 to display product information corresponding to the product identification code on each virtual cell (S350). Such a process may be described in more detail with reference to FIG. 6.

FIG. 6 shows a method for matching a product identification code to each virtual cell generated on a display of a bar type electronic shelf label capable of touch input according to an embodiment of the present disclosure.

Referring to FIG. 6, an electronic shelf label may receive a virtual cell selection input and a product identification input in a state in which a total of four virtual cells are generated as shown in (a) of FIG. 6. The controller 120 may control to display a virtual keypad and an input result window in each virtual cell of the display 110 to receive the virtual cell selection input and the product identification input.

In this case, the virtual cell selection input may be an input to select any one of a plurality of virtual cells displayed on the display 110 and may be set as an input of touching any one of the virtual cells. Although not shown in the drawing, the controller 120 may control brightness of the selected virtual cell to be brighter than that of an unselected virtual cell based on receiving the virtual cell selection input. The user may distinguish the selected virtual cell from other virtual cells based on the brightness thereof.

In addition, the product identification input is an input including an identification code of a product to distinguish a product from other products. The product identification input may be applied by the user using a virtual keypad displayed on the selected virtual cell.

For example, when the user applies an input to select a first virtual cell shown in (a) of FIG. 6 and applies a product identification input using the virtual keypad of the first virtual cell, an input result window of the first virtual cell displays the received product identification input (S330). Similarly, the user may select second to fourth virtual cells, apply a product identification input. Therefore, the received product identification input may be displayed on each virtual cell.

An embodiment of inputting a barcode of each product as a product code input is shown in the drawing, but the present disclosure is not limited thereto. In another embodiment, a unique code of each product in an individual store may be input as a product code input.

Subsequently, the controller 120 matches the product identification code to each virtual cell (S340). Subsequently, the controller 120 controls the display 110 to display product information corresponding to the product identification code in each virtual cell (S350).

The product information may include information on the name, price, manufactured date, and related product of a product.

In an embodiment of the present disclosure, product information corresponding to the product identification code may be stored in the management server 200. In this case, the controller 120 transmits a result of matching the product identification code to each virtual cell to the management server 200, receives product information corresponding to each product identification code from the management server 200, and controls the display 110 to display the product information.

In another embodiment of the present disclosure, the product information corresponding to the product identification code may be stored in a memory of the controller 120. In this case, the controller 120 may control the display 110 to display the product information stored in the memory without communication with the management server 200.

Referring back to FIG. 3, as described with reference to FIGS. 4 to 6, the manager may display the product information to consumers using the bar type electronic shelf label 100 capable of touch input according to an embodiment of the present disclosure.

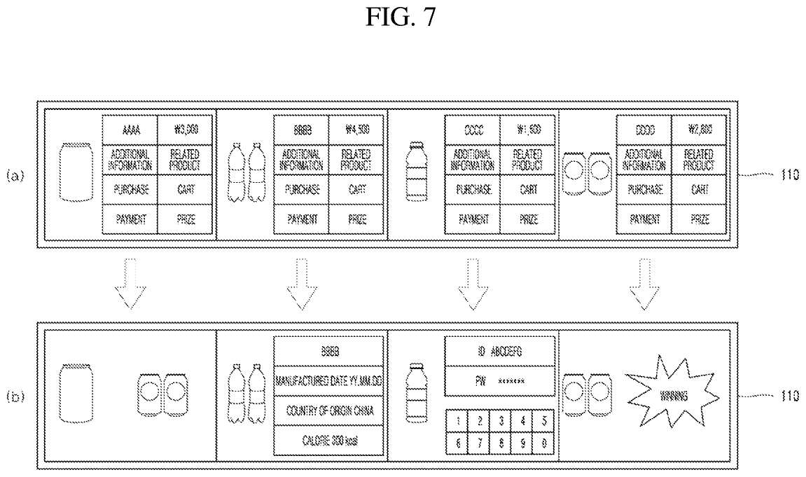

FIG. 7 shows a screen change occurring according to user input when a bar type electronic shelf label capable of touch input according to an embodiment of the present disclosure is operated in a consumer mode.

Referring to FIG. 7, when an electronic shelf label 100 is operated in the consumer mode, an embodiment of a screen that may be displayed on each virtual cell may be confirmed. Referring to (a) of FIG. 7, product information including a product picture, the product name, and the product price is displayed in each virtual cell. Referring to a leftmost virtual cell of (a) of FIG. 7, it may be seen that a picture of a can-shaped product is displayed on the left, and the product information such as the product name of AAAA and the price of [symbol] 3,000 are displayed in the right table. Product pictures, product names, and prices are displayed in each virtual cell as product information in the embodiment of (a) of FIG. 7, but the present disclosure is not limited thereto, and other pieces of information may be displayed as the product information. In addition, it may be seen that menus that consumers may select such as additional information, related product, purchase, cart, payment, and prize are additionally displayed in the table on the right side of each virtual cell of (a) of FIG. 7. The electronic shelf label 100 may perform other operations based on reception of an input of touching additional information, related product, purchase, cart, payment, and prize from the user.

Based on the reception of the related product display input from the user, the controller 120 may control the related product information to be displayed on the virtual cell that has received the related product display input for a preset display time period.

The related product display input is an input to display related product information on the related product to the product displayed on the virtual cell and an input to touch the related product menu displayed on the display 110 may be set as the related product display input. In addition, the display time period is a time period for which the related product information is displayed based on the reception of the related product display input and may be preset by the manager.

In this case, the related product information is information on product related to the currently displayed product, may be preset by the manager, and may be stored in a memory of the controller 120 or the management server 200.

When the related product information is stored in the management server 200, based on the controller 120 receiving the related product display input, the controller 120 receives the related product information from the management server 200 and controls the display 110 to display the related product information.

When the related product information is stored in the memory of the controller 120, based on the controller 120 receiving the related product display input, the controller 120 may control the display 110 to display the related product information without additional communication.

Referring to the leftmost virtual cells of (a) and (b) of FIG. 7, when a user applies a related product display input by touching a related product menu displayed on the leftmost virtual cell of (a) of FIG. 7, related product information may be displayed by the controller 120 as shown in the leftmost virtual cell of (b) of FIG. 7.

Based on receiving an additional information display input from the user, the controller 120 may control to display the additional information on the product currently displayed on the display 110 for a preset display time period in the virtual cell that has received the additional information display input.

The additional information display input is an input of displaying additional information related to a product displayed on the virtual cell, and an input to touch the additional information menu displayed on the display 110 may be set as the additional information display input.

In this case, the additional information may be preset by the manager and may be stored in the memory of the controller 120 or the management server 200. In addition, the display time period is a time period for which the additional information is displayed based on receiving the additional information display input and may be preset by the manager.

When the additional information is stored in the management server 200, based on the controller 120 receiving the additional information display input, the controller 120 may receive the additional information from the management server 200 and control the display 110 to display the additional information.

When the additional information is stored in the memory of the controller 120, based on the controller 120 receiving the additional information display input, the controller 120 may control the display 110 to display additional information without additional communication.

Referring to the second virtual cells from the left of (a) and (b) of FIG. 7, when the user applies an additional information display input by touching the additional information menu displayed on the second virtual cell from the left of (a) of FIG. 7, additional information may be displayed by the controller 120 as shown in the second virtual cell from the left of (b) of FIG. 7.

Based on receiving a purchase wish input from the user, the controller 120 may control a purchase information set window to be displayed in the virtual cell that has received the purchase wish input.

The purchase wish input is an input of displaying a screen in order for the user to purchase a product displayed on the virtual cell, and an input of touching the purchase menu, the cart menu, or the payment menu displayed on the display 110 may be set as the purchase wish input.

Referring to the third virtual cells from the left of (a) and (b) of FIG. 7, a purchase set window may be displayed by the controller 120 as shown in the third virtual cell from the left of (b) of FIG. 7 when the user applies a purchase wish input by touching a purchase menu, a cart menu, or a payment menu displayed on the third virtual cell from the left of (a) of FIG. 7.

In addition, when receiving user information input in a state in which the purchase information set window is displayed, the controller 120 may transmit, to the management server 200, the user information input and a product identification code corresponding to the virtual cell displaying the purchase information set window.

In this case, the user information input may be an input including a unique ID capable of distinguishing a user from other users and a password to authenticate it. As described above, the controller 120 may transmit the user information input and the product identification code to the management server 200 to perform a purchase operation, a cart management operation, or a payment operation by the management server 200.

Based on receiving a prize lottery input from the user, the controller 120 may control to display a winning phrase or a losing phrase in a virtual cell that has received the prize lottery input based on a preset winning probability.

The prize lottery input is an input of a prize drawing for a product displayed on the virtual cell and may be set as an input to touch a prize menu displayed on the display 110. In this case, the prize menu may be displayed only when an event related to the product displayed in the virtual cell is in held. In addition, the winning probability thereof may be preset by the manager.

Referring to rightmost virtual cells of (a) and (b) of FIG. 7, when the user applies a prize lottery input by touching the prize menu displayed on the rightmost virtual cell of (a) of FIG. 7, a drawing result (win or lose) may be displayed by the controller 120 as shown in the rightmost virtual cell of (b) of FIG. 7

As described above, the controller 120 controls the display 100 to display various pieces of information according to the consumer selection, thereby providing various pieces of information to the consumers.

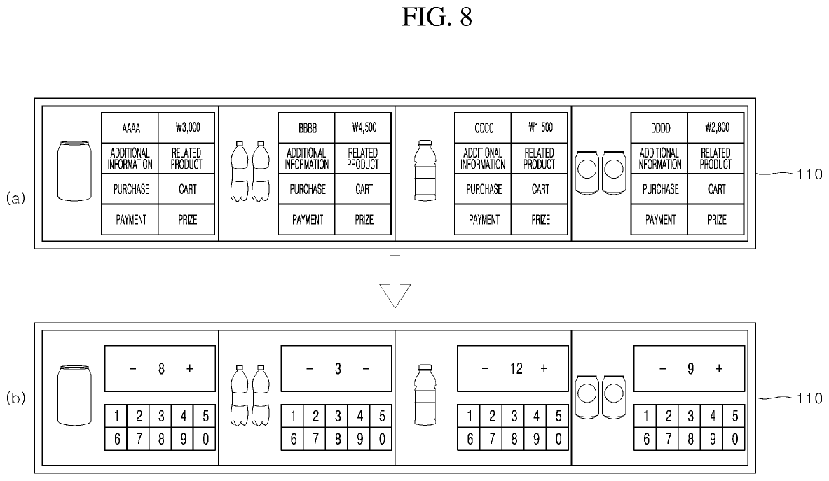

FIG. 8 shows a screen displayed on a display when a bar type electronic shelf label capable of touch input according to an embodiment of the present disclosure receives an inventory management input.

Referring to FIG. 8, when a controller 120 receives the inventory management input from the user, an inventory set window displayed on the display 110 may be identified.

The inventory management input is an input to operate in an inventory management mode in which the user may manage the inventory using an electronic shelf label 100 operating in a consumer mode or a manager mode. The inventory management input may be set as a special input known only to the manager to prevent the consumer visiting the store from changing the inventory of the product by arbitrarily manipulating the electronic shelf label 100 provided in the store.

In an embodiment of the present disclosure, the inventory management input may be set as an input of touching the display 110 according to a certain rhythm. In another embodiment of the present disclosure, the inventory management input may be set as an input of pressing adjustment switching button (not shown) additionally provided on the electronic shelf label 100. In yet another embodiment of the present disclosure, the inventory management input may be set as an input of pressing a preset password using a virtual keypad displayed on the display 110.

Upon receiving the inventory management input while the electronic shelf label 100 is operating in the consumer mode as shown in (a) of FIG. 8, the controller 120 may control the display 110 to display the inventory management window as shown in (b) of FIG. 8. In an embodiment of the present disclosure, the inventory management window may include product information, an input result window, and a virtual keypad.

Based on receiving an inventory quantity input from the user in a state in which the inventory set window is displayed, the controller 120 may transmit the inventory quantity input and a product identification code corresponding to the virtual cell that received the inventory quantity input to the management server 200.

The inventory quantity input is an input corresponding to the quantity of products currently remaining in the display stand of the store. In one embodiment of the present disclosure, the user may apply the inventory quantity input by touching a (+) icon, a (−) icon displayed on the input result window or the virtual keypad of the inventory set window.

The controller 120 transmits the received inventory quantity input and the product identification code corresponding to the virtual cell that has received the inventory quantity input to the management server 200. Therefore, the management server 200 may manage the inventory thereof.

According to the present disclosure, the electronic shelf label 100 may be operated in the inventory management mode to enable easy inventory management of the display products for the manager.

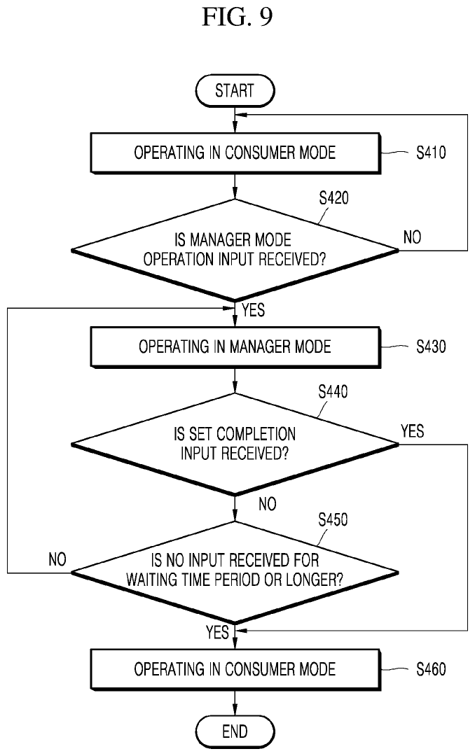

FIG. 9 is a flowchart of a method for switching between a consumer mode and a manager mode of a bar type electronic shelf label capable of touch input according to an embodiment of the present disclosure.

Referring to FIG. 9, when there is no manager mode operation input, a controller 120 controls a display 110 to be operated in the consumer mode (S410).

When the controller 120 controls the display 110 to be operated in the consumer mode as described above, the controller 120 determines reception or non-reception of the manager mode operation input from a user (S420).

The manager mode operation input is an input of operating, in the manager mode, the electronic shelf label 100 which is operating in the consumer mode. The manager mode operation input may be set as a special input known only to the manager to prevent a consumer visiting a store from changing displayed product information by arbitrarily manipulating the electronic shelf label 100 provided in the store.

In an embodiment of the present disclosure, the manager mode operation input may be set as an input of touching the display 110 according to a preset rhythm. In another embodiment of the present disclosure, the manager mode operation input may be set as an input of pressing a switching button (not shown) that is additionally provided on the electronic shelf label 100. In yet another embodiment of the present disclosure, the manager mode operation input may be set as a preset password input applied using a virtual keypad displayed on the display 110.

Based on a determination that the controller 120 does not receive the manager mode operation input, the controller 120 controls the display 110 to be continuously operated in the consumer mode (S410).

Based on a determination that the controller 120 receives the manager mode operation input, the controller 120 controls the display 110 to be operated in a manager mode (S430).

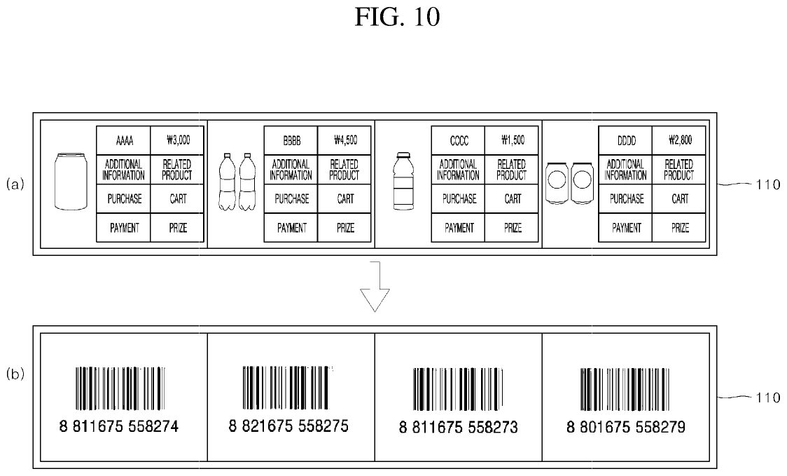

In this case, after the controller 120 controls the display 110 to be operated in the manager mode by receiving the manager mode operation input, the controller 120 may control the display 110 to display a barcode corresponding to a product identification code matching to each virtual cell. This configuration may be confirmed with reference to FIG. 10.

FIG. 10 shows a screen change occurring when a mode of a bar type electronic shelf label capable of touch input according to an embodiment of the present disclosure is switched from a consumer mode to a manager mode.

Referring to FIG. 10, when a controller 120 receives a manager mode operation input from a user while the controller 120 controls a display 110 to be operated in the consumer mode as shown in (a) of FIG. 10, the controller 120 controls a mode of the display 110 to be switched to the manager mode and the display 110 to be operated in the manager mode. Subsequently, the controller 110 may control the display 110 to display a barcode corresponding to an identification code of a product matching to each virtual cell as shown in (b) of FIG. 10. That is, when the electronic shelf label 100 is operated in the manager mode, the barcode corresponding to the identification code of the matched product may be displayed on each virtual cell.

Returning back to FIG. 9, the controller 120 determines reception or non-reception of a set completion input from the user (S440) when the electronic shelf label 100 is operated in the manager mode based on the manager mode operation input being received.

The set completion input is an input of operating, in the consumer mode, the electronic shelf label 100 while operating in the manager mode by completing the necessary manipulation in the manager mode by the user.

Based on a determination that the controller 120 receives the set completion input, the controller 120 controls the display 110 to be operated in the consumer mode (S460).

Based on a determination that the controller 120 does not receive the set completion input, the controller 120 determines reception or non-reception of an input from the user for a preset waiting time period or longer (S450).

In this case, the waiting time period is a maximum time period for which the electronic shelf label 100 waits for a next input reception when the electronic shelf label 100 is operated in the manager mode. Therefore, the controller 120 may determine that the user has no intention to additionally manipulate in the manager mode based on input being not received from the user for the preset waiting time period or longer.

Based on a determination that the controller 120 does not receive an input from the user for the waiting time period or longer, the controller 120 controls the display 110 to be operated in the consumer mode (S460).

In addition, based on a determination that the controller 120 receives an input from the user for the waiting time period or longer, the controller 120 controls the display 110 to be continuously operated in the manager mode (S430).

That is, based on the determination that the set completion input is received or no input is received for the waiting time period or longer, the controller 120 controls the display 110 to be operated in the consumer mode (S460).

As described above, the electronic shelf label 100 according to an embodiment of the present disclosure may operate while switching the mode thereof to the manager mode or the consumer mode.

The manager may change product information displayed on the display 110 using the bar type electronic shelf label 100 capable of touch input according to the present disclosure as described above even without an additional terminal device. In addition, the controller 120 displays various pieces of information according to the selection of the consumer on the display 110 to provide various pieces of information to consumers using the bar type electronic shelf label 100 capable of touch input according to the present disclosure. In addition, the manager may easily manage the inventory of the displayed products using the bar type electronic price display 100 capable of touch input according to the present disclosure.

The present disclosure has been described as described above with reference to exemplary drawings, but the present disclosure is not limited to the embodiments and drawings disclosed herein, and various modifications can be made by those skilled in the art within the scope of the technical idea of the present disclosure. Further, even if working effects obtained based on configurations of the present disclosure are not explicitly described in the description of embodiments of the present disclosure, effects predictable based on the corresponding configuration have to be recognized.

1. An electronic shelf label, comprising:
a display configured to receive touch input from a user and display information to a user on a screen; and
a controller configured to control the screen displayed by the display based on the input received through the display,
wherein the controller is configured to:
control the display to be operated in a consumer mode in which product information is displayed to the user or a manager mode in which a screen displayed in the consumer mode is set,
when the controller controls the display to be operated in the manager mode, generate a virtual cell by dividing the screen based on a division input received from the user and match a product identification code to each virtual cell based on a virtual cell selection input and a product identification input received from the user, and
when the controller controls the display to be operated in the consumer mode, controls the display to display product information corresponding to the product identification code on the each virtual cell.

2. The electronic shelf label of claim 1, wherein the division input comprises at least one of an input having a number of virtual cells desired to be generated, a touch input having the number corresponding to the number of virtual cells desired to be generated, a touch input to a desired location to be divided, or an input to receive a preset template from a management server.

3. The electronic shelf label of claim 1, wherein the controller is configured to: when the controller controls the display to be operated in the manager mode, adjust a size and the number of virtual cells based on a virtual cell adjustment input from the user after receiving the division input.

4. The electronic shelf label of claim 1, wherein the controller is configured to: when the controller controls the display to be operated in the consumer mode, based on an additional information display input being received from the user, control additional information to be displayed on the virtual cell that has received the additional information display input for a preset display time period.

5. The electronic shelf label of claim 1, wherein the controller is configured to: when the controller controls the display to be operated in the consumer mode, based on a related product display input being received from the user, control related product information to be displayed on a virtual cell that has received the related product display input for a preset display time period.

6. The electronic shelf label of claim 1, wherein the controller is configured to: when the controller controls the display to be operated in the consumer mode, based on a purchase wish input being received from a user, control a purchase information set window to be displayed on a virtual cell that has received the purchase wish input.

7. The electronic shelf label of claim 6, wherein the controller is configured to: based on user information input being received in a state in which the purchase information set window is displayed, transmit the user information input and the product identification code corresponding to the virtual cell displaying the purchase information set window to a management server.

8. The electronic shelf label of claim 1, wherein the controller is configured to: when the controller controls the display to be operated in the consumer mode, based on a prize lottery input being received from the user, control a winning phase or a losing phase to be displayed on a virtual cell that has received the prize lottery input based on a preset winning probability.

9. The electronic shelf label of claim 1, wherein the controller is configured to: based on an inventory management input being received from the user, control the display to display an inventory set window.

10. The electronic shelf label of claim 9, wherein the controller is configured to: based on an inventory quantity input received in a state in which the inventory set window is displayed, transmit, to the management server, the inventory quantity input and a product identification code corresponding to the virtual cell that has received the inventory quantity input.

11. The electronic shelf label of claim 1, wherein the controller is configured to: when the controller controls the display to be operated in the consumer mode, based on a manager mode operation input received from the user, control the display to be operated in the manager mode.

12. The electronic shelf label of claim 11, wherein the manager mode operation input comprises at least one of an input of touching the display in accordance with a preset rhythm, an input of pressing adjustment switching button of the electronic shelf label, or a preset password input.

13. The electronic shelf label of claim 11, wherein the controller is configured to: based on the manager mode operation input received and the display being operated in the manager mode, control the display to display a barcode corresponding to the product identification code matching to the each virtual cell.

14. The electronic shelf label of claim 1, wherein the controller is configured to: when the controller controls the display to be operated in the manager mode, based on no input received from the user for a preset waiting time period or a set completion input received from the user, control the display to be operated in the consumer mode.
